(19) United States
(12) Patent Application Publication
(10) Pub. No.: US 2003/0169704 A1
(43) Pub. Date: Sep. 11, 2003

(54) Mobile communication terminal and management method for always preserved PDP context using for this mobile communication terminal

(75) Inventor: Yasuyo Okanoue, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/377,886

(22) Filed: Mar. 4, 2003

(30) Foreign Application Priority Data
Mar. 5, 2002 (JP) 059425/2002

(51) Int. Cl. H04Q 7/00

(52) U.S. Cl. 370/328; 370/331

(57) ABSTRACT

A mobile communication terminal and a management method for an always preserved PDP context using for the mobile communication terminal, in which not delivering data to the mobile communication terminal from a push contents server can be avoided and also reestablishing an undesirable always preserved PDP context can be avoided, are provided. The timer in the mobile communication terminal is started at the time when the mobile communication terminal moved from a service area to an out of service area. The full measuring time value in the mobile communication terminal is set to be smaller than that of a PRAUT (periodic routing area update timer) in an RNC (resource network controller). In case that the mobile communication terminal returned to the service area, when the timer in the mobile communication terminal was full but within the full measuring time value of the PRAUT, the always preserved PDP context is reestablished, and it is not necessary to establish an undesirable new PDP context needing a new IP address. Therefore, the IP address of the mobile communication terminal, which was decided at the time when the always preserved PDP context was established and has been held in the push contents server, is not renewed meaninglessly. With this, error delivery of the push data caused by not matching the IP address can be avoided.

### BACKGROUND OF THE INVENTION

The present invention relates to a mobile communication terminal and a management method for an always preserved PDP (packet data protocol) context using for this mobile communication terminal, in particular, in a push service for the mobile communication terminal.

### DESCRIPTION OF THE RELATED ART

In the use of mobile communication terminals, delivery services of information to the mobile communication terminals, using the Internet, have recently become popular. That is, video games, images, information of companies, online magazines, and so forth are delivered to the mobile communication terminals via the Internet.

For delivering the information, a push service, utilized the preserved PDP context, which always holds an IP (Internet protocol) address and is kept in a state that data can be delivered at any time, defined in the 3GPP (3rd generation partnership project) standard, is used.

The push service is a service that automatically delivers contents (data) to the mobile communication terminals from push contents servers, by using an always preserved PDP context being a logic session of an air network.

That is, when the always preserved PDP context is established between a mobile communication terminal and a GGSN (gateway GPRS (general packet radio service) supporting node), the GGSN can hold an IP address allocated to the mobile communication terminal. Consequently, a push contents server can deliver data to the IP address of the mobile communication terminal via the GGSN.

However, when the mobile communication terminal using radio communication moved to an out of service area or to a place where the radio condition was not good, a squelch breakdown occurs frequently. Consequently, there is a problem that it becomes impossible to hold the always preserved PDP context constantly.

### SUMMARY OF THE INVENTION

It is therefore an object of the present invention to provide a mobile communication terminal and a management method for an always preserved PDP context using for the mobile communication terminal, in which not delivering data to the mobile communication terminal from a push contents server can be avoided and also reestablishing an undesirable always preserved PDP context can be avoided.

According to a first aspect of the present invention, for achieving the object mentioned above, there is provided a mobile communication terminal, which has been always connected to a PDP context being a logic circuit that is terminated at an end node via an intermediate node from the mobile communication terminal, for receiving a push service from a push contents server. The mobile communication terminal provides a time measuring means, which starts to measure time at the time when the mobile communication terminal moved from a service area to an out of service area, and whose full measuring time value is smaller than that of a timer measuring by the intermediate node, which measures the time until a call between the mobile communication terminal and the intermediate node is detached after the mobile communication terminal moved to the out of service area, and a PDP context management that reestablishes the PDP context, in case that the mobile communication terminal moved to a service area from the out of service area after the time measuring means finished measuring the full measuring time value before the timer measuring by the intermediate node did not finish measuring its own full measuring time value.

According to a second aspect of the present invention, in the first aspect, the PDP context management provides a PDP context establishing means for establishing the PDP context when the power supply of the mobile communication terminal is turned on, and a PDP context using means for using the established PDP context when the mobile communication terminal moved to a service area from the out of service area before the time measuring means finishes measuring the full measuring time value.

According to a third aspect of the present invention, in the first aspect, the PDP context is a logic session of an air network that is terminated at an MTF.

According to a fourth aspect of the present invention, there is provided a management method for an always preserved PDP context using for a mobile communication terminal, which has been always connected to a PDP context being a logic circuit that is terminated at an end node via an intermediate node from the mobile communication terminal, for receiving a push service from a push contents server. The management method provides the steps of, measuring time of the period between the mobile communication terminal moved from a service area to an out of service area and the mobile communication terminal returned to a service area from the out of service area by a first timer, and measuring time of the period that the mobile communication terminal stayed in the out of service area after the mobile communication terminal moved from the service area by a second timer. And a full measuring time value of the first timer is smaller than that of the second timer, and the full measuring time value of the second timer is the time until a call between the mobile communication terminal and the intermediate node is detached after the mobile communication terminal moved to the out of service area. And the management method further provides the step of; reestablishing the PDP context, in case that the mobile communication terminal moved to a service area from the out of service area after the first timer finished the full measuring time value before the second timer did not finish measuring the full measuring time value.

According to a fifth aspect of the present invention, in the fourth aspect, the management method for an always preserved PDP context provides the steps of, establishing the PDP context when the power supply of the mobile communication terminal is turned on, and using the established PDP context when the mobile communication terminal moved to a service area from the out of service area before the first timer does not finish measuring the full measuring time value.

According to a sixth aspect of the present invention, in the fourth aspect, the PDP context is a logic session of an air network that is terminated at an MTF.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a software and protocol and function structure for transmitting a request for delivering data and receiving delivered data at a mobile communication terminal of an embodiment of the present invention;

FIG. 2 is a diagram showing a network at the embodiment of the present invention;

FIG. 3 is a diagram showing a case in which a squelch breakdown occurred in an active state of the PDP context at the embodiment of the present invention;

FIG. 4 is a diagram showing a shift of states combined a PMM state and a PDP state at the embodiment of the present invention; and

FIG. 5 is a timing chart showing the operation of a PDP-MNG shown in FIG. 1.

### DESCRIPTION OF THE PREFERRED EMBODIMENT

Referring now to the drawings, an embodiment of the present invention is explained in detail.

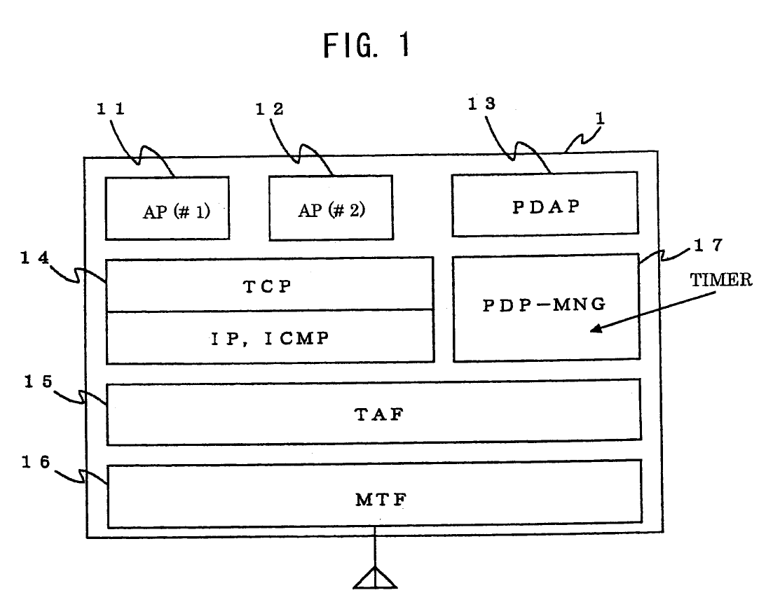

FIG. 1 is a block diagram showing a software and protocol and function structure for transmitting a request for delivering data and receiving delivered data at a mobile communication terminal of the embodiment of the present invention. As shown in FIG. 1, the software and protocol and function structure for transmitting a request for delivering data and receiving delivered data at a mobile communication terminal 1 of the embodiment of the present invention consists of an AP (#1) 11, an AP (#2) 12, a PDAP 13, a TCP & IP & ICMP 14, a TAF 15, an MTF 16, and a PDP-MNG 17. In this, the AP stands for application software, and the PDAP stands for push data processing application software. The push data are data that are delivered from a push contents server to a mobile communication terminal. The TCP stands for transmission control protocol, the IP stands for Internet protocol, and the ICMP stands for Internet control message protocol. The TAF stands for terminal adaptation function, the MTF stands for mobile termination function, and the PDP-MNG stands for PDP context management.

The AP (#1) 11 and the AP (#2) 12 are application software such as browser, Java (R) software, and E-mail software. The PDAP 13 is application software that receives the push data by always working in the background.

At the mobile communication terminal 1, push data, received from the always preserved PDP context that is terminated at the MTF 16, are transferred to the TCP & IP & ICPM 14 via the TAF 15, and the protocol processing is applied to the push data. And the push data applied the protocol processing are transferred to the PDAP 13.

The PDP-MNG 17 establishes the always preserved PDP context when the power supply of the mobile communication terminal 1 is turned on. And also the PDP-MNG 17 has at least processing logic to reestablish the always preserved PDP context, assuming that the mobile communication terminal 1 moves to an out of service area for a long time, that is, a squelch breakdown occurs in the out of service area, and also assuming that the mobile communication terminal 1 receives a request to make the always preserved PDP context inactive from a network. Therefore, not delivering the push data can be avoided, by that the mobile communication terminal 1 and the network have the same recognition about a PMM (packet mobility management) state and a PDP context state. Furthermore, the PDP-MNG 17 provides a timer for measuring time.

As mentioned above, the push service is a service that automatically delivers contents (data) from a push contents server to a mobile communication terminal, and uses an always preserved PDP context being a logic session of an air network.

That is, when the always preserved PDP context has been established between the mobile communication terminal 1 and a GGSN, the GGSN can hold an IP address allocated to the mobile communication terminal 1. Therefore, the push contents server can deliver data to the IP address of the mobile communication terminal 1 via the GGSN.

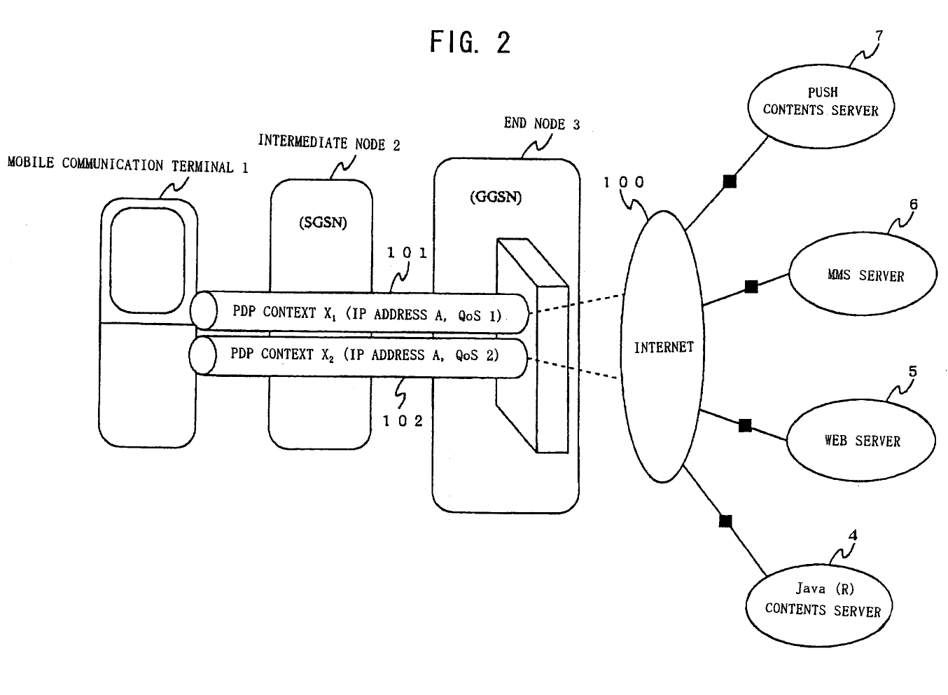

FIG. 2 is a diagram showing a network at the embodiment of the present invention. In FIG. 2, the mobile communication terminal 1 receives data from servers, such as a Java (R) contents server 4, a web server 5, and an MMS server 6, and also receives push data from a push contents server 7, connected to the Internet 100 by accessing them, by using a PDP context 101 and a PDP context 102 being logic circuits, relayed at an intermediate node 2 and terminated at an end node 3. As the intermediate node 2, a SGSN (serving GPRS supporting node) is used, and as the end node 3 a GGSN is used. The MMS stands for multi media service.

The always preserved PDP context must be always connected, therefore, the PDP context X₁ 101 is established as the always preserved PDP context by making it be in an always preserved state. And a QoS 1 level (background) suitable to the push data or an interactive traffic class suitable to the push data is applied to the PDP context X₁ 101, which is always preserved. In this, the QoS stands for quality of service. The PDP context X₂ 102, being the secondary PDP context, is established for an application, which needs a QoS 2 level being different from the QoS 1 level, for example, delivering and receiving moving pictures, which needs a traffic having a streaming traffic class.

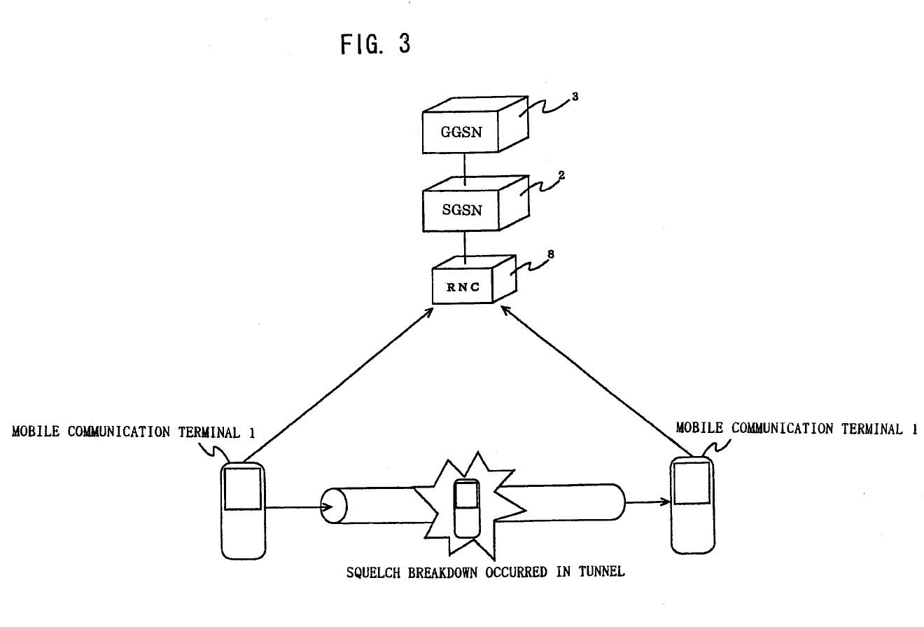

FIG. 3 is a diagram showing a case in which a squelch breakdown occurred in an active state of the PDP context at the embodiment of the present invention. In FIG. 3, a state, in which the squelch breakdown occurred in a tunnel, is shown, when the mobile communication terminal 1 has been connected to the end node (GGSN) 3 via a radio network controller (RNC) 8 and the intermediate node (SGSN) 2. That is, the mobile communication terminal 1 entered the out of service area by moving into the tunnel.

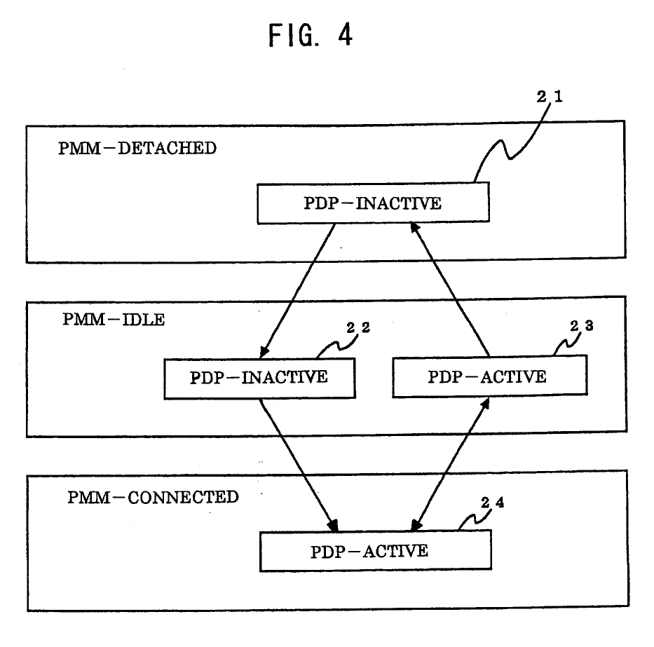

FIG. 4 is a diagram showing a shift of states combined a PMM state and a PDP state at the embodiment of the present invention. In FIG. 4, a state 21, in which the PMM is in a call detached state and the PDP is in an inactive state, is a state that the PDP context has not been established, because the position of the mobile communication terminal 1 has not been registered.

A state 22, in which the PMM is in an idle state and the PDP is in an inactive state, is a state that an RRC (radio resource control) connection and the PDP context have not been established, because the position has been registered but a call has not occurred.

A state 24, in which the PMM is connected and the PDP is in an active state, is a state that packet data have been received and transmitted, because the RRC connection and the PDP context have been established.

A state 23, in which the PMM is in the idle state and the PDP is in the active state, is a state that the PDP context has been established and is in the active state, although the RRC connection has been disconnected because the packet data have not occurred for a long time.

The basic principle of the operation of the network at the embodiment of the present invention is explained.

The intermediate node 2 and the end node 3 conform to the 3GPP standard, and even when the PDP context being in the active state detects a squelch breakdown, the PDP context is not made to be in the inactive state immediately. That is, for, example, even when the mobile communication terminal 1 was in the state shown in FIG. 3 by moving into the tunnel and the squelch breakdown occurred, the PDP context is not made to be inactive immediately.

At the state 23, in which the PMM is in the idle state and the PDP is in the active state, that is, in the always preserved state of the PDP context, when a squelch breakdown occurs, a PRAUT (periodic routing area update timer) (default: 54 minutes) in the RNC 8 is started by the intermediate node 2. In case that the mobile communication terminal 1 stays in an out of service area for more than the full measuring time value of the PRAUT, a call is detached and the state 23 is shifted down to the state 21, in which the PMM is in the call detached state and the PDP is in the inactive state.

At this state 21, the IP address, which has been held by the push contents server 7, is cleared, because the PDP context became inactive. Consequently, it becomes impossible that the push data is delivered.

Shifting up from the state 23 to the state 24, that is, shifting up from the always preserved state of the PDP context (the state 23), in which the PMM is in the idle state and the PDP is in the active state, to the state 24, in which the PMM is connected and the PDP is in the active state, becomes possible, by establishing paging and the RRC connection based on the data transmission from the mobile communication terminal 1.

However, at a conventional case, in case that the state is that the intermediate node 2 and the end node 3 hold a current PDP context, when the mobile communication terminal 1 requests to make a new PDP context active, the intermediate node 2 makes the current PDP context inactive and reestablishes the new PDP context. At this time, the IP address of the mobile communication terminal 1 is newly decided, and the old IP address of the mobile communication terminal 1, being held in the push contents server 7, is renewed.

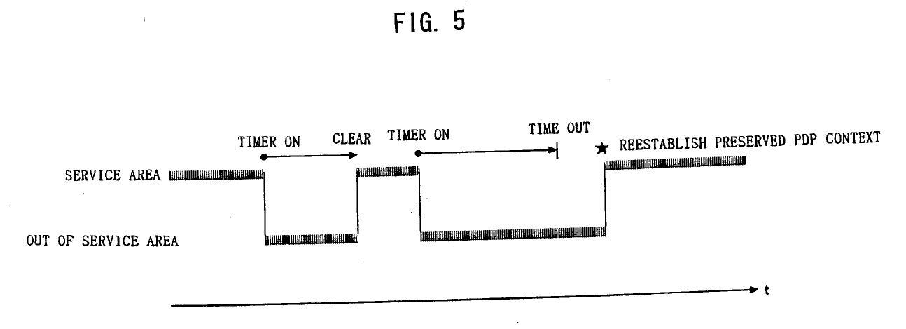

FIG. 5 is a timing chart showing the operation of the PDP-MNG 17 shown in FIG. 1. Referring to FIG. 5, the operation of the PDP-MNG 17 is explained.

In case that the power supply of the mobile communication terminal 1 is turned on, even data, which is transmitted from the mobile communication terminal 1, do not exist, when the mobile communication terminal 1 is in a service area, the PDP-MNG 17 requests the TAF 15 to transmit a request, which makes the PDP context active, to the network.

When the PDP-MNG 17 receives the state information, which the PDP context is inactive, from the network (the intermediate node (SGSN) 2 or the end node (GGSN) 3, the PDP-MNG 17 requests the TAF 15 to transmit a request, which makes the PDP context active (request to reestablish the PDP context), to the network.

Referring to FIG. 5, the operation of the PDP- MNG 17 is explained in more detail. As shown in FIG. 5, when the PDP-MNG 17 detects a change that the mobile communication terminal 1 moved from a service area to an out of service area, the PDP-MNG 17 makes the timer in the PDP-MNG 17 start. The timer can be cleared at the time only the mobile communication terminal 1 moved to a service area or the power supply of the mobile communication terminal 1 was turned off.

Even when the mobile communication terminal 1 moved to an out of service area, the information of the PDP context has been held. In case that the mobile communication terminal 1 returned to a service area after moved to the out of service area, and the timer in the PDP-MNG 17 was not full (time out), the mobile communication terminal 1 uses the PDP context as it is.

The timer full state signifies the state of the network was shifted down to the state 21, in which the PMM is in the call detached state and the PDP is in the inactive state, and is the state that the push data cannot be delivered. When the mobile communication terminal 1 returned to the service area, the mobile communication terminal 1 establishes the RRC connection, and requests the TAF 15 to transmit a request, which makes the PDP context active (request to reestablish the PDP context), to the network.

In case that the mobile communication terminal 1 returned to a service area, when the timer in the PDP-MNG 17 was full but the timer (PRAUT) in the RNC was not in a time out (full) state, the PDP-MNG 17 requests the TAF 15 to transmit a request, which makes the PDP context active (request to reestablish the PDP context), to the network.

In this, it is necessary that the full measuring time value of the timer in the PDP-MNG 17 is set to be smaller than that of the PRAUT (default: 54 minutes) in the RNC 8, which is started by the intermediate node 2.

In case that the mobile communication terminal 1 returned to a service area from the out of service area after measuring the full measuring time value of the PRAUT in the RNC 8, a new IP address is required to access the push contents server 7.

At the embodiment of the present invention mentioned above, the timer in the PDP-MNG 17 of the mobile communication terminal 1 is started at the time when the mobile communication terminal 1 moved from the service area to the out of service area. The full measuring time value of the timer in the PDP-MNG 17 is set to be smaller than that of the PRAUT in the RNC 8. In case that the mobile communication terminal 1 returned to a service area, when the timer in the PDP-MNG 17 was full but within the full measuring time value of the PRAUT, the always preserved PDP context is reestablished, and it is not necessary to establish an undesirable new PDP context needing a new IP address. Therefore, the IP address of the mobile communication terminal 1, which was decided at the time when the always preserved PDP context was established and has been held in the push contents server 7, is not renewed meaninglessly. With this, error delivery of the push data caused by not matching the IP address can be avoided.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A mobile communication terminal, which has been always connected to a PDP context being a logic circuit that is terminated at an end node via an intermediate node from said mobile communication terminal, for receiving a push service from a push contents server, comprising:
a time measuring means, which starts to measure time at the time when said mobile communication terminal moved from a service area to an out of service area, and whose full measuring time value is smaller than that of a timer measuring by said intermediate node, which measures the time until a call between said mobile communication terminal and said intermediate node is detached after said mobile communication terminal moved to said out of service area; and
a PDP context management that reestablishes said PDP context, in case that said mobile communication terminal moved to a service area from said out of service area after said time measuring means finished measuring said full measuring time value before said timer measuring by said intermediate node did not finish measuring its own full measuring time value.

2. A mobile communication terminal in accordance with claim 1, wherein:
said PDP context management, comprising:
a PDP context establishing means for establishing said PDP context when the power supply of said mobile communication terminal is turned on; and
a PDP context using means for using said established PDP context when said mobile communication terminal moved to a service area from said out of service area before said time measuring means finishes measuring said full measuring time value.

3. A mobile communication terminal in accordance with claim 1, wherein:
said PDP context is a logic session of an air network that is terminated at an MTF.

4. A management method for an always preserved PDP context using for a mobile communication terminal, which has been always connected to a PDP context being a logic circuit that is terminated at an end node via an intermediate node from said mobile communication terminal, for receiving a push service from a push contents server, comprising the steps of:
measuring time of the period between said mobile communication terminal moved from a service area to an out of service area and said mobile communication terminal returned to a service area from said out of service area by a first timer; and
measuring time of the period that said mobile communication terminal stayed in said out of service area after said mobile communication-terminal moved from said service area by a second timer, wherein:
a full measuring time value of said first timer is smaller than, that of said second timer, and said full measuring time value of said second timer is the time until a call between said mobile communication terminal and said intermediate node is detached after said mobile communication terminal moved to said out of service area, and
said management method for said always preserved PDP context, further comprising the step of:
reestablishing said PDP context, in case that said mobile communication terminal moved to a service area from said out of service area after said first timer finished said full measuring time value before said second timer did not finish measuring said full measuring time value.

5. A management method for an always preserved PDP context in accordance with claim 4, further comprising the steps of establishing said PDP context when the power supply of said mobile communication terminal is turned on; and
using said established PDP context when said mobile communication terminal moved to a service area from said out of service area before said first timer does not finish measuring said full measuring time value.

6. A management method for an always preserved PDP context in accordance with claim 4, wherein:
said PDP context is a logic session of an air network that is terminated at an MTF.
